(19) United States
(12) Patent Application Publication
(10) Pub. No.: US 2003/0085972 A1
(43) Pub. Date: May 8, 2003

(54) Method for inserting images on printing plates

(76) Inventors: Karl Erich Albert Schaschek, Thungen (DE); Georg Schneider, Wurzburg (DE)

Correspondence Address: Douglas R Hanscom, Jones Tullar & Cooper, Eads Station, PO Box 2266, Arlington, VA, 22202, US

(21) Appl. No.: 10/240,736

(22) PCT Filed: Feb. 22, 2001
(86) PCT No.: PCT/DE01/00697

(30) Foreign Application Priority Data
Apr. 14, 2000 (DE) 10018547.9

(51) Int. Cl. B41J 2/01

(52) U.S. Cl. 347/101

(57) ABSTRACT

The invention concerns a method for inserting images on printing plates, wherein a printing plate is prepared with an ink-accepting layer and an ink-repelling layer applied thereon. According to the invention, a developing fluid is sprayed on the ink-repelling layer by an inkjet printing group in accordance with an image to be printed, by means of which the ink-repelling layer is etched or dissolved in the sprayed areas for swelling or adhesion promotion is eliminated. The etched or dissolved areas of the ink-repelling layer are removed. A waterless printing plate having an ink-repelling layer made of silicon is especially used.

The invention relates to a method in accordance with the preamble of claim 1 for applying images on printing plates.

Various methods are known for placing images on planographic or offset printing plates. For one, photosensitive plates are exposed to lasers and thereafter developed in accordance with a wet-chemical process. Moreover, the prior art shows so-called thermo-plates, wherein a linkage of the uppermost layer is achieved by means of laser energy, and the process triggered in this way is brought to a close in a further step. Another arrangement was selected in connection with so-called thermally ablative plates. There, an absorbent intermediate layer is caused to evaporate by means of a laser, whereupon the ink-repellent layer above it is dissolved and can be removed in a subsequent step (see U.S. Pat. No. 5,487,338).

It is furthermore known to place an image on a printing plate by applying a suitable fluid. In accordance with U.S. Pat. No. 4,003,312, a silicon solution corresponding to the image to be printed is sprayed on a printing plate substrate and is cured there, by means of which the required surface structure of the printing plate is created. However, processing of the silicon layer to be sprayed on is difficult. Added to this is the curing of the sprayed-on silicon layer.

JP 10-119 230 A discloses a method for producing a printing plate. The ink-absorbent layer, i.e. the layer to be imprinted, of this printing plate is located on the water-absorbent layer. To produce the plate, the ink-absorbent layer is sprayed with an image-forming material by means of an inkjet, so that the areas not to be imprinted become water-soluble.

The object of the invention is based on creating a method for applying images to printing plates.

In accordance with the invention, this object is attained by means of the characteristics of claim 1.

The advantages which can be attained by means of the invention reside in particular in that a developing fluid corresponding to an image to be printed is applied to the ink-repellent layer with an inkjet printing unit, by means of which the ink-repellent layer is loosened or dissolved in the sprayed area, and the loosened or dissolved areas of the ink-repellent layer are removed.

Thus, by spraying or imprinting the uppermost layer by means of the inkjet printing unit, the uppermost layer is directly stripped off, or is loosened or dissolved to such an extent that it can be stripped off. The properties of the ink-repellent layer are changed by means of the developing fluid in such a way that it can be easily removed in the areas imprinted with the developing fluid. The areas not imprinted with the developing fluid remain on the printing plate, so that the desired surface structure is achieved. The ink-absorbent layer is exposed in the areas from which the ink-repellent layer is removed, so that the printing plate is provided with ink-absorbent areas corresponding to the image to be printed and ink-repellent areas. The developing fluid can be precisely applied droplet by droplet with the aid of the inkjet printing unit.

Substantial advantages are achieved by the direct loosening or dissolving of the surface of the printing plate in the manner described. A higher degree of dependability of the inkjet method is achieved, in particular the drying of the ink known with the conventional methods is prevented. The print head often becomes gummed up when spraying the silicon solution on or when applying light-repellent printing inks for the photographic development of the printing plates, which made extensive cleaning necessary, or even made the print head completely unusable. In contrast to this, the developing fluid used with the present invention cannot gum up the print head of the inkjet printing unit.

Moreover, further steps for processing the printing plate such as, for example, the curing of the sprayed-on silicon or synthetic resin solution, or the customary photographic development of photosensitive layers following fixation of the areas not to be removed, are omitted.

In a particularly advantageous manner it is now possible in connection with the described application of images on a printing plate to do without the clean room conditions in the printing press, which had to be adhered to so far in connection with the known methods, since no material is applied, material is only removed.

It is possible in principle to employ various printing plates. However, a waterless printing plate with an ink-repellent layer of silicon is preferably used. Various layers are considered as ink-absorbent layer, which withstand the developing fluid for the ink-repellent layer, it is possible in particular to provide a polyethylene foil, which is placed under the silicon layer.

The developing fluid to be used is usefully matched to the layer to be loosened or dissolved. A solvent is used in particular, by means of which the respective areas of the ink-repellent layer are liquefied. By means of this it is possible to remove the silicon layer in a particularly simple manner from the loosened areas in a subsequent step.

Several variants can be considered for removing the loosened or removed areas of the top layer of the printing plate. For example, the loosened or dissolved areas can be removed with the first printing ink, or mechanically by means of a suitable cleaning unit. The loosened or dissolved area of the top layer of the printing plate are preferably removed by mechanical stresses on the printing plate, in particular a printing process. By means of this the required process steps for the image application are minimized and an efficient, as well as simple, image application on the printing plate is achieved.

In place of the previously described loosening or dissolution and removal of the ink-repellent layer, it is also possible in principle to print an ink-absorbing top layer with developing fluid in the manner mentioned by means of an inkjet printing unit and in this way to loosen and dissolve and remove it, so that in this case areas of the ink-repellent layer located underneath are exposed. However, preferably a printing plate with a top ink-repellent layer, in particular made of silicon, is used in the previously described manner, which is removed in areas corresponding to the image to be printed.

An exemplary embodiment of the invention is represented in the drawings and will be described in greater detail in what follows.

Shown are in:

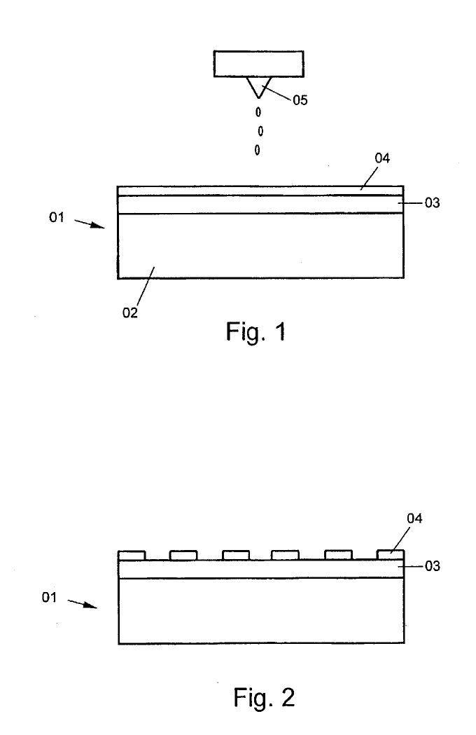

FIG. 1, a schematic representation of a printing plate in the raw state prior to the application of developing fluid by means of a print head in accordance with a preferred embodiment of the invention,

FIG. 2, a schematic representation of the printing plate in FIG. 1 after the application of the image.

The printing plate 01 represented in FIG. 1 has a support layer, or substrate 02, which can be made of aluminum and has a sufficient thickness for obtaining the desired mechanical properties. An ink-absorbent layer 03, as well as an ink-repellent layer 04 lying on top of it have been placed on it. The ink-absorbent layer 03 can be embodied as a polyethylene foil. Its thickness can lie in the range between 5 to 50 μm, preferably it can be approximately 20 μm. The ink-repellent layer 04 consists of silicon. It thickness is suitably selected. It can lie in the range of a few μm, in the embodiment shown it is approximately 2 μm. An adhesive or base layer can be placed between the substrate 02 and the ink-absorbent layer 03. A titanium oxide layer is provided in'the exemplary embodiment shown.

A waterless printing plate of the firm Presstek (PearlDry) is preferably used, such as is described in U.S. Pat. No. 5,487,338, to which specific reference is made in connection with the structure of the printing plate.

In order to loosen, or remove, the silicon layer 04 area-wise in accordance with the image to be printed, a solvent is applied droplet by droplet as the developing fluid to the surface of the silicon layer 04 by means of the print head 05, schematically represented in FIG. 1, of an inkjet printing unit. The control of the print head 05 takes place in the manner customary for inkjet printers. The solvent, which has been applied in accordance with the image to be printed, liquefies the silicon in those areas to which it has been applied, so that the silicon can be easily removed from these areas. In place of liquefaction, only a change in the properties of the silicon layer 04, for example by swelling, or reduction of the adhesion to the layer underneath it, can take place. The loosened silicon layer 04, or its loosened areas, can be removed with the first ink or by means of a suitable cleaning unit. It is advantageous here that the loosened silicon is present as a liquid. The liquefied silicon can be removed by means of the mechanical stresses of the printing process in particular.

The finished printing plate with the images applied and with the areas of the silicon layer 04 removed is represented in FIG. 2. The printing plate ol is brought into contact with printing ink, which only adheres to the ink-absorbent polyethylene layer 03, i.e. to the areas from which the silicon layer 04 was removed. In accordance with this, the images applied to the printing plate are transferred to the carrier to be imprinted.

List of Reference Numerals

01 Printing plate

02 Substrate

03 Ink-absorbent layer, silicon layer

04 Ink-repellent layer, polyethylene layer

05 Print head

1. A method for applying images to a printing plate, wherein a printing plate (01), having an ink-absorbent layer (03) and an ink-repellent layer (04) placed on it, is made available, with an inkjet printing unit (05) a developing fluid is applied to the ink-repellent layer (04) in accordance with an image to be printed, with which the ink-repellent layer (04) is changed in the charged areas, and the changed areas of the ink-repellent layer (04) are removed.

2. The method in accordance with the preceding claim, wherein a printing plate (01) for waterless offset printing, having an ink-repellent layer (04) of silicon, is employed.

3. The method in accordance with one of the preceding claims, wherein a developing fluid is used by means of which the sprayed areas of the ink-repellent layer (04) are liquefied.

4. The method in accordance with one of the preceding claims, wherein the loosened or dissolved areas of the ink-repellent layer are removed by mechanical stresses on the printing plate (01).
